(19) United States
(12) Patent Application Publication
(10) Pub. No.: US 2005/0054369 A1
(43) Pub. Date: Mar. 10, 2005

(54) System and method for wireless LAN connection, wireless terminal and computer program thereof

(75) Inventor: Takuya Murakami, Tokyo (JP)

Correspondence Address: Patent Group;Choate, Hall & Stewart, Exchange Place, 53 State Street, Boston, MA, 02109-2804, US

(73) Assignee: NEC Corporation

(21) Appl. No.: 10/919,610

(22) Filed: Aug. 17, 2004

(30) Foreign Application Priority Data
Aug. 18, 2003 (JP) 294392/2003

(51) Int. Cl. H04Q 7/20

(52) U.S. Cl. 455/525

(57) ABSTRACT

A wireless terminal 1 obtains an access point ID from an access point 3 and receives setting information S from a setting information distribution server 2. Thereafter, the wireless terminal 1 transmits the setting information S and the access point ID to the access point 3. When the wireless terminal 1 is authenticated in the access point 3, the wireless terminal 1 receives a connection approval signal to a wireless LAN 4 from the access point 3.

### FIELD OF THE INVENTION

The present invention relates to a technical field of connecting a wireless terminal to a wireless local area network (herein after referred to as a “wireless LAN”) via an access point.

### BACKGROUND OF THE INVENTION

Heretofore, there has been developed a wireless LAN connection system of connecting a wireless terminal to a wireless local area network (hereinafter referred to as a “wireless LAN”) via an access point.

As an example of such a wireless LAN connection system, Japanese Patent Laid-Open No. 2002-318788 has been proposed. In this gazette, a user attaches an IC card, in which setting information for connecting to a wireless LAN is previously stored, to a wireless terminal. Accordingly, the wireless terminal is connected to the wireless LAN by use of the setting information read from the attached IC card (see FIG. 1 in the gazette).

More specifically, the conventional wireless LAN connection system described above requires a physical medium, such as the IC card, when acquiring the setting information for connecting to the wireless LAN in the wireless terminal.

Thus, the user of the wireless terminal needs to prepare an IC card storing setting information of a wireless LAN, to which he/she wishes to connect the wireless terminal, before connecting the wireless terminal to the wireless LAN. Therefore, a user using a plurality of wireless LANs of different kinds needs to previously prepare a plurality of IC cards storing setting information corresponding to those wireless LANs. In addition, the user has to keep and carry those IC cards so that he/she can use the IC cards while appropriately switching the cards as the need arises. Furthermore, the user also and always needs to know the kind of the IC card attached to the wireless terminal.

As described above, the conventional wireless LAN connection system has a problem that the user is forced to perform burdensome operations such as selection, switching, keeping and management of the IC cards according to the wireless LAN to which he/she wishes to connect the wireless terminal.

### SUMMARY OF THE INVENTION

The present invention was made to solve the conventional problem described above. It is an object of the present invention to easily and surely connect a wireless terminal to a wireless LAN via an access point.

In order to achieve the foregoing object, a wireless LAN connection system according to the present invention has the following configuration.

Specifically, a wireless LAN connection system includes a wireless terminal (1, 1A, 1B, 1C) and an access point (3) connecting the wireless terminal to a wireless LAN (4). The system further includes setting information provision means (2, 2A, 9, 9A) for providing setting information for connection to the wireless LAN. In the system, the wireless terminal includes setting information acquisition means (information acquisition unit 13, 13A, 13B) for acquiring the setting information from the setting information provision means and connection request means (connection request unit 12, 15) for receiving, from the access point, identification information capable of specifying the access point and transmitting the identification information and the setting information to the access point in order to request connection to the wireless LAN through the access point. Moreover, the access point connects the wireless terminal to the wireless LAN upon receipt of the setting information and the identification information from the wireless terminal.

Here, the setting information includes, for example, at least information for authenticating the wireless terminal in the access point.

Moreover, in another preferred embodiment, the setting information is previously encrypted setting information, the system further includes a setting information decoder (7) for decoding the encrypted setting information and, in the wireless terminal (1A, 1C), the connection request means transfers the encrypted setting information to the setting information decoder and, upon receipt of decoded setting information from the setting information decoder, transmits the decoded setting information and the identification information to the access point.

Moreover, in another preferred embodiment, the setting information provision means (2) is disposed in a service provision range by the access point.

Moreover, the setting information provision means (2) and the setting information acquisition means (13) may be connected to each other, for example, through short-range communication based on prescribed standards.

Note that the object described above is also achieved by a method corresponding to the wireless LAN connection system having the foregoing configuration and the wireless terminal constituting a part of the system described above.

Moreover, the object described above is also achieved by a computer program which allows a computer to realize the wireless terminal constituting a part of the wireless LAN connection system described above and by a computer-readable storage medium storing the computer program.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram showing a configuration of a wireless LAN connection system according to a first embodiment of the present invention.

FIG. 2 is a flowchart showing processing of connecting a wireless terminal in the wireless LAN connection system according to the first embodiment.

FIG. 3 is a flowchart showing processing of controlling an access point in the wireless LAN connection system according to the first embodiment.

FIG. 4 is a block diagram showing a configuration of a wireless LAN connection system according to a second embodiment of the present invention.

FIG. 5 is a flowchart showing processing of connecting a wireless terminal in the wireless LAN connection system according to the second embodiment.

FIG. 6 is a flowchart showing decryption processing of a setting information decryption server in the wireless LAN connection system according to the second embodiment.

FIG. 7 is a block diagram showing a configuration of a wireless LAN connection system according to a third embodiment of the present invention.

FIG. 8 is a block diagram showing a configuration of a wireless LAN connection system according to a fourth embodiment of the present invention.

### DETAILED DESCRIPTION OF THE PREFERRED EMBODIMENTS

Preferred embodiments of the present invention will now be described in detail in accordance with the accompanying drawings.

With reference to the drawings, embodiments of a wireless LAN connection system according to the present invention will be described in detail below.

<First Embodiment>

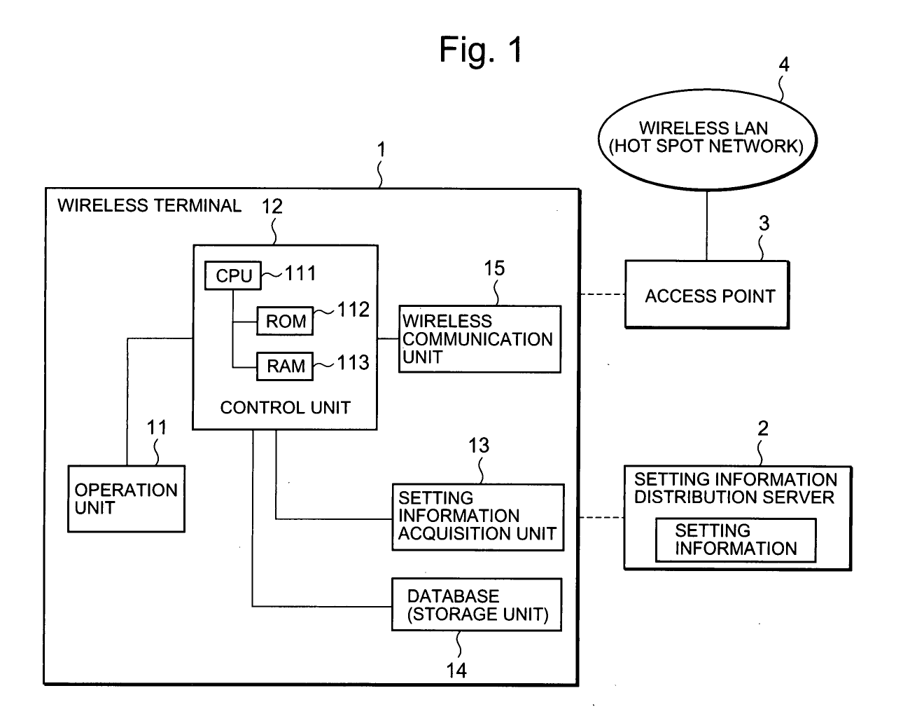

FIG. 1 is a block diagram showing a configuration of a wireless LAN connection system according to a first embodiment of the present invention.

The wireless LAN connection system shown in FIG. 1 includes, in a broad sense, a wireless terminal 1, a setting information distribution server 2, an access point 3 and a wireless LAN (hot spot network) 4.

The wireless terminal 1 is a mobile terminal such as a portable telephone, a PHS (Personal Handyphone System) and a PDA (Personal Digital Assistant).

In this embodiment, the setting information distribution server 2 is allowed to correspond to the access point 3 and disposed (located) in the vicinity of the access point 3 (the wireless LAN 4). Specifically, the setting information distribution server 2 is disposed, for example, within a wireless communication range (service provision range, hot spot) of the access point 3. In this embodiment, the setting information distribution server 2 constantly transmits setting information S with a predetermined period, for example.

Note that an operation of transmitting the setting information S by the setting information distribution server 2 is not limited to constant transmission. For example, the setting information distribution server 2 may be configured to perform the transmission operation only when the wireless terminal 1 (user) is positioned in the wireless communication range of the access point 3.

Here, the setting information S includes at least information for authenticating the wireless terminal 1 in the access point 3. To be more specific, the setting information S is, for example, key information encrypted for security (WEP: Wired Equivalent Privacy) which is used in connecting the wireless terminal 1 to the wireless LAN 4 by the access point 3.

Note that, in some cases, the setting information S includes a URL (Uniform Resource Locator) for accessing a predetermined Web page, an IP (Internet Protocol) address, a subnet address ID and the like, for example, in accordance with communication specifications between the wireless terminal 1 and the access point 3 (the wireless LAN 4).

The setting information distribution server 2 and the wireless terminal 1 are connected so as to be able to communicate with each other through short-range wireless communication based on prescribed standards. To be more specific, the short-range wireless communication based on the prescribed standards is, for example, short-range wireless communication such as infrared communication of IRDA and the like or Bluetooth (trademark).

When the wireless terminal 1 is positioned in the hot spot (service provision range) of the access point 3 due to movement of the user carrying the wireless terminal 1, the wireless terminal 1 receives a radio wave sent from the access point 3 and retrieves an access point ID from this radio wave.

Here, the access point ID is a specific identifier (identification information) which is capable of specifying the access point 3 transmitting the access point ID. For example, the access point ID is an ESS-ID (Extended Service Set Identifier) and the like, indicating a character string.

When the wireless terminal 1 is positioned in the hot spot of the access point 3, the wireless terminal 1 can receive the setting information S from the setting information distribution server 2 as described above. Accordingly, the wireless terminal 1 transmits the access point ID and the setting information S to the access point 3 so as to request connection to the wireless LAN 4.

When the access point 3 determines that the access point ID and the setting information S, which are transmitted from the wireless terminal 1, are information corresponding to the access point 3, the access point 3 connects the wireless terminal 1 to the wireless LAN 4. In this event, to the wireless terminal 1, the access point 3 transmits a predetermined radio signal indicating that the connection is approved (hereinafter called a “connection approval signal”) Here, the access point 3 determines whether or not the access point ID and the setting information S are the “corresponding information” based on the fact that:
the access point ID received from the wireless terminal 1 coincides with the access point ID transmitted by the access point 3, and
that the setting information S received from the wireless terminal 1 coincides with the setting information S transmitted by the setting information distribution server 2 set so as to correspond to the access point 3.
   (Configuration of Wireless Terminal 1)

Next, with reference to FIG. 1, an internal configuration of the wireless terminal 1 will be described.

The wireless terminal 1 includes an operation unit 11, a control unit 12, a setting information acquisition unit 13, a database (storage unit) 14 and a wireless communication unit 15.

In this embodiment, the wording “unit” means a function unit (function module) including at least any one of hardware such as several electronic device, circuit element, sensing devise, etc. and software implemented therein.

The operation unit 11 is a pointing device, a plurality of buttons (key switches) and the like for entering operations by the user. In this embodiment, the user performs predetermined operations to the operation unit 11, for example, when he/she wishes to connect the wireless terminal 1, which he/she uses, to the wireless LAN 4 via the access point 3.

The setting information acquisition unit 13 is a communication unit which performs short-range communication typified by the above-described infrared communication, Bluetooth and the like with the setting information distribution server 2. The setting information acquisition unit 13 receives the setting information S.

The database 14 stores the access point ID and the setting information S in a state of being associated with each other.

Accordingly, the wireless communication unit 15 performs wireless communication with the access point 3.

The control unit 12 controls operations of the respective units in the wireless terminal 1 described above. Specifically, the control unit 12 controls the entire operations of the wireless terminal 1 by executing a software program, which is read from a ROM (read only memory) 112, in a CPU (Central Processing Unit) 111 while using a RAM (random access memory) 113 as a work area.

Upon receipt of the connection approval signal, the wireless terminal 1 is connected to the wireless LAN 4. Thus, it is made possible to transmit signals from the wireless terminal 1 to the wireless LAN 4 and to allow the wireless terminal 1 to receive signals from the wireless LAN 4.

(Connection Operation of Wireless LAN Connection System)

Next, in line with individual operations of the wireless terminal 1 and the access point 3, operations of the wireless LAN connection system according to this embodiment described above will be described. Note that the setting information distribution server 2 is assumed to constantly transmit the setting information S, for example, as described above.

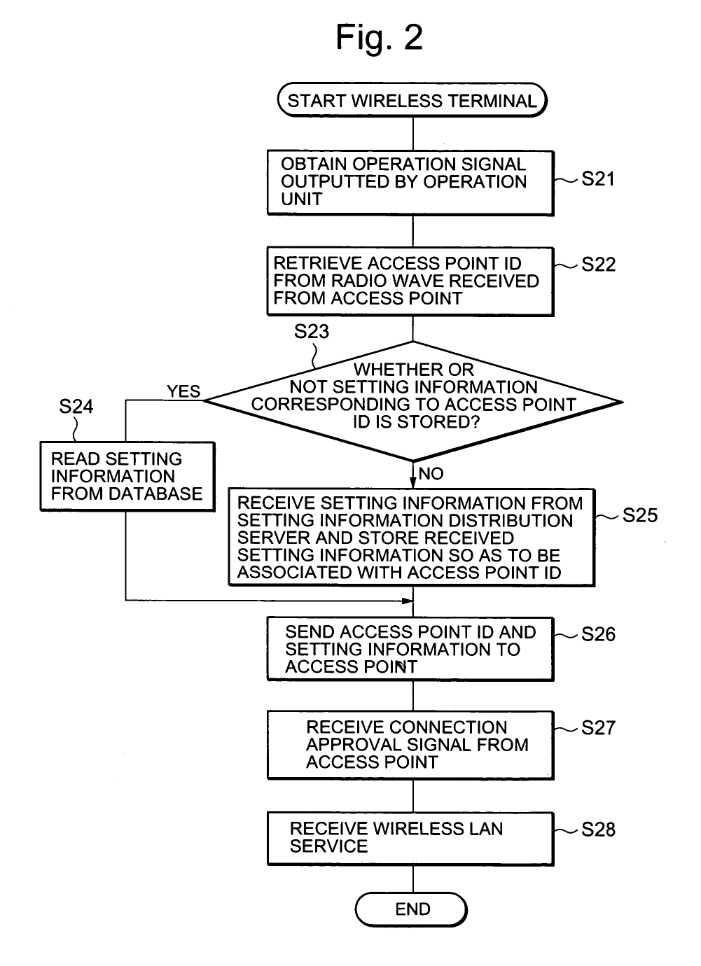

FIG. 2 is a flowchart showing processing of connecting the wireless terminal in the wireless LAN connection system according to the first embodiment. The flowchart shows a processing procedure of a software program executed by the CPU 111 in the wireless terminal 1 shown in FIG. 1.

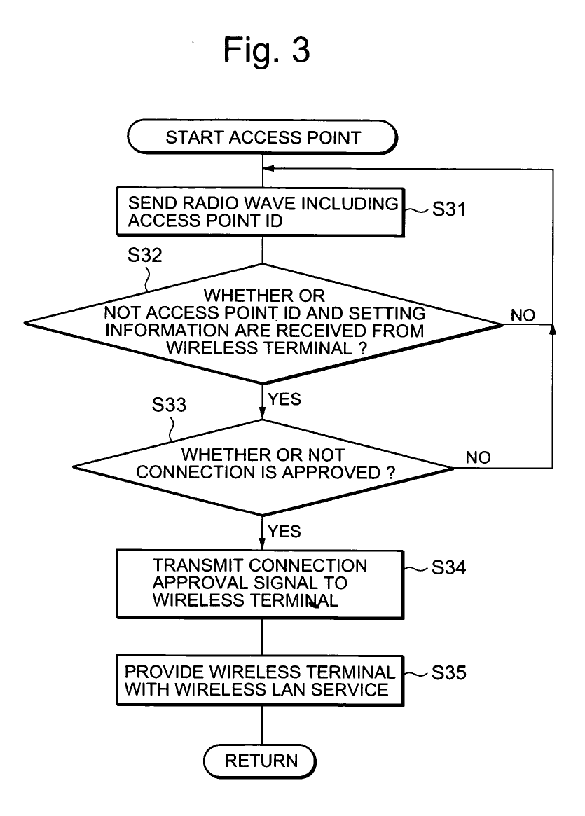

Moreover, FIG. 3 is a flowchart showing processing of controlling the access point in the wireless, LAN connection system according to the first embodiment. The flowchart shows a processing procedure of a software program executed by an unillustrated CPU in the access point 3 shown in FIG. 1.

When the user of the wireless terminal 1 wishes to connect the wireless terminal 1 to the wireless LAN 4, the user performs a predetermined input operation to the operation unit 11. In the control unit 12 of the wireless terminal 1, the CPU 111 detects the predetermined input operation in the operation unit 11 and recognizes that a connection operation to the wireless LAN 4 via the access point 3 is requested (Step S21 in FIG. 2).

In this embodiment, the access point 3 sends out a radio wave including an access point ID that is identification information (identifier) capable of specifying the access point 3 (Step S31 in FIG. 3). Thus, when the wireless terminal 1 is positioned in a hot spot (service provision range) of the access point 3 due to movement of the user carrying the wireless terminal 1, the wireless terminal 1 can receive the radio wave sent from the access point 3. Accordingly, the CPU 111 receives the radio wave by using the wireless communication unit 15 and retrieves an access point ID from the received radio wave (Step S22 in FIG. 2). Specifically, the access point ID obtained in this step is identification information (identifier) capable of specifying the access point 3 forming a hot spot in which the wireless terminal 1 (user) is currently positioned.

For example, in the case where the wireless terminal 1 (user) has utilized the access point 3 before or the like, the CPU 111 stores the access point ID and the setting information S so as to correspond to each other in the database 14. Accordingly, the CPU 111 determines whether or not the same access point ID as that newly obtained this time in Step S22 is stored in the database 14 in a state of being associated with corresponding setting information S (Step S23 in FIG. 2).

When the CPU 111 determines, in Step S23, that the access point ID and the corresponding setting information S are already stored, the CPU 111 reads the setting information S from the database 14 (Step S24).

Meanwhile, when the CPU 111 determines, in Step S23, that the access point ID and the corresponding setting information S have not yet been stored, the CPU 111 performs processing of Step S25.

Specifically, in Step S25 in FIG. 2, the CPU 111 controls the setting information acquisition unit 13 to receive setting information S from the setting information distribution server 2 which corresponds to the access point 3 and is disposed in the vicinity thereof. Furthermore, the CPU 111 stores the access point ID obtained in Step S22 and the setting information S received in this step so as to be associated with each other in the database 14.

Note that, in Step S25, depending on the specification of the short-range communication adopted between the setting information distribution server 2 and the setting information acquisition unit 13 of the wireless terminal 1 or depending on the relationship with the installation location, it is also assumed that the user is required to move the wireless terminal 1 close to the setting information distribution server 2. In this case, the CPU 111 is required to perform processing of appropriately telling the user to move the wireless terminal 1 close to the setting information distribution server 2.

The CPU 111 controls the wireless communication unit 15 to transmit the setting information S read from the database 14 in Step 24 or the setting information S newly obtained in Step S25 and the access point ID obtained in Step S22 to the access point 3 (Step S26 in FIG. 2).

When the access point 3 receives the access point ID and the setting information from the wireless terminal 1 (Step S32 in FIG. 3), the access point 3 performs connection approval based on the received information (Step S33 in FIG. 3).

When the connection approval of the wireless terminal 1 is obtained in Step S33, the access point 3 transmits a connection approval signal to the wireless terminal 1 and permits the wireless terminal 1 to be connected to the wireless LAN 4 (Step S34 in FIG. 3).

Accordingly, in the wireless terminal 1, the CPU 111 receives the connection approval signal sent from the access point 3 via the wireless communication unit 15 (Step S27). Thus, the wireless terminal 1 can receive services through the wireless LAN 4, which are provided via the access point 3 (Step S28 in FIG. 2 and Step S35 in FIG. 3).

According to the first embodiment described above, when the setting information S required for the connection to the wireless LAN 4 is not stored in the database 14 of the wireless terminal 1, the wireless terminal 1 can acquire the setting information S from the setting information distribution server 2 provided in the vicinity of the access point 3. The series of operations are performed automatically without particular consciousness of the user of the wireless terminal 1 or are performed just by moving the wireless terminal 1 carried by the user close to the setting information distribution server 2. In addition, the series of operations are also common to any access points 3. Therefore, it is possible to relieve the user of troubles such as using a plurality of IC cards while appropriately switching the cards as in the case of the conventional wireless LAN connection.

Specifically, according to the wireless LAN connection system of this embodiment, the wireless terminal 1 can be easily and surely connected to the wireless LAN 4 via the access point 3.

<Second Embodiment>

Next, description will be given of a second embodiment based on the wireless LAN connection system according to the first embodiment described above.

In the following description, characteristic portions of this embodiment will be mainly described. Moreover, constituent components similar to those of the first embodiment described above are denoted by the same reference numerals and repetitive description will be omitted.

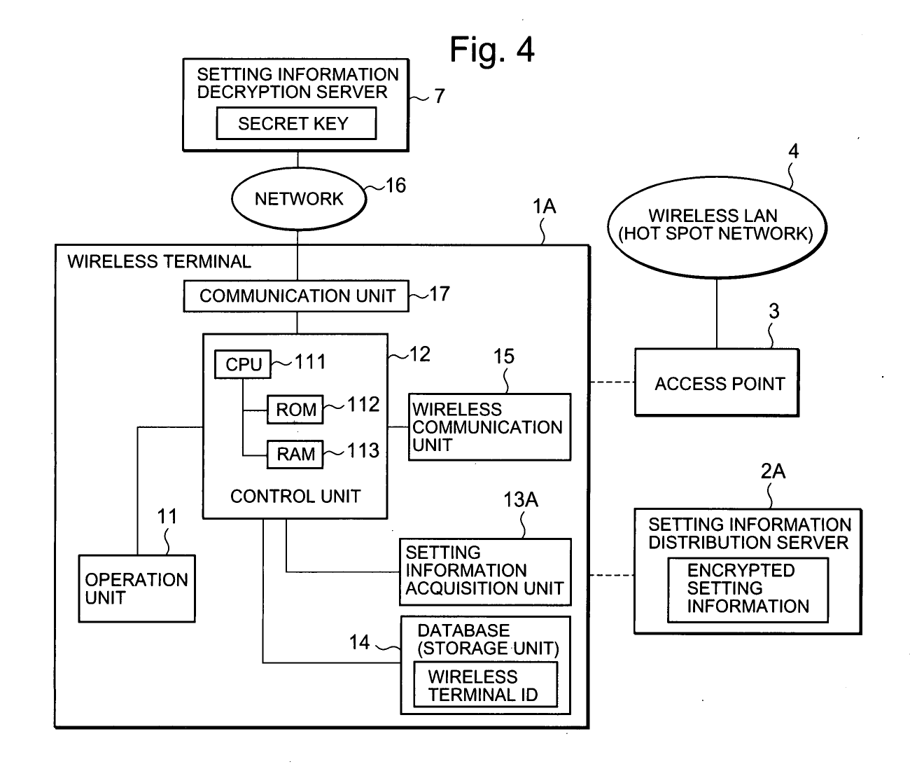

FIG. 4 is a block diagram showing a configuration of a wireless LAN connection system according to the second embodiment of the present invention.

The wireless LAN connection system shown in FIG. 4 includes, in a broad sense, a wireless terminal 1A, a setting information distribution server 2A, an access point 3, a wireless LAN 4, a network 16 and a setting information decryption server 7. Specifically, the configuration of the wireless LAN connection system according to the second embodiment is different from that of the wireless LAN connection system according to the first embodiment (FIG. 1) in further including the network 16 and the setting information decryption server 7.

The setting information decryption server 7 performs communication of which security with the wireless terminal 1A is ensured through the network 16. Thus, in addition to the internal configuration of the wireless terminal 1 in the first embodiment, the wireless terminal 1A further includes a communication unit 17 capable of communication through the network 16. Moreover, in the wireless terminal 1A, a wireless terminal ID is previously stored in the database 14, the wireless terminal ID being used for authentication of the wireless terminal 1A in the setting information decryption server 7 when encrypted communication is performed through the network 16.

Here, the network 16 is a network different from that provided by the access point 3 (the wireless LAN 4). To be more specific, the network 16 is a network (for example, i mode (trademark) or the like) which includes a public wireless telephone line (mobile telephone network) and the Internet, for example.

The setting information distribution server 2A constantly transmits the setting information S described in the first embodiment in a state of being encrypted (the encrypted setting information S will be hereinafter called “encrypted setting information ES”). Here, the encrypted setting information ES is information obtained by encrypting the setting information S by use of a predetermined public key.

In this embodiment, the setting information decryption server 7 includes a secret key corresponding to the public key used to generate the encrypted setting information ES. The setting information decryption server 7 utilizes the secret key to decrypt the encrypted setting information ES obtained through the wireless terminal 1A.

Note that an installation location of the setting information distribution server 2A, configurations of the setting information distribution server 2A and a setting information acquisition unit 13A, communication specifications and the like may be similar to those of the first embodiment.

Here, description will be given of a point in which a connection operation in the wireless LAN connection system (FIG. 4) including the system configuration described above is different from that of the first embodiment.

When the wireless terminal 1A obtains the encrypted setting information ES from the setting information distribution server 2A, the wireless terminal 1A transmits the encrypted setting information ES to the setting information decryption server 7 through the network 16 together with a wireless terminal ID of its own which is read from the database 14.

When the wireless terminal 1A can be authenticated by use of the received wireless terminal ID, the setting information decryption server 7 generates setting information S by decrypting the encrypted setting information ES by use of the secret key. Accordingly, the setting information decryption server 7 transmits the setting information S to the wireless terminal 1A through the network 16. The operation subsequently performed by the wireless terminal 1A, which has received the setting information S, between the wireless terminal 1A and the access point 3 is similar to that of the first embodiment.

(Connection Operation of Wireless LAN Connection System)

Next, operations of the wireless LAN connection system according to this embodiment described above will be described. Note that, also in this embodiment, the access point 3 executes the control processing (FIG. 3) described in the first embodiment. Moreover, as described above, the setting information distribution server 2A is assumed to constantly transmit the encrypted setting information ES, for example. Thus, operations of the wireless terminal 1A and the setting information decryption server 7 will be mainly described below.

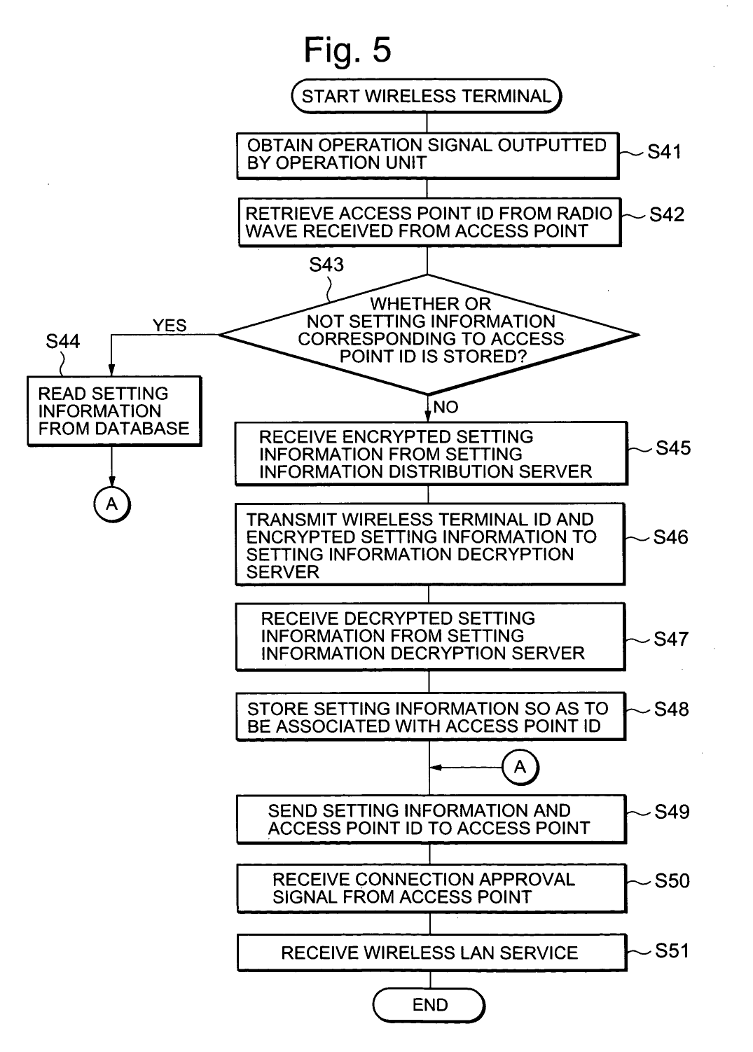

FIG. 5 is a flowchart showing processing of connecting the wireless terminal in the wireless LAN connection system according to the second embodiment. The flowchart shows a processing procedure of a software program executed by the CPU 111 in the wireless terminal 1A shown in FIG. 4.

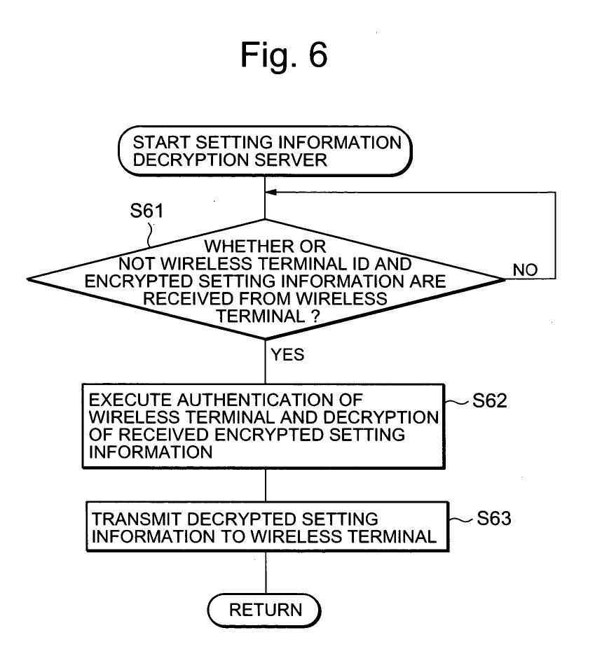

Moreover, FIG. 6 is a flowchart showing decryption processing of the setting information decryption server in the wireless LAN connection system according to the second embodiment. The flowchart shows a processing procedure of a software program executed by an unillustrated CPU in the setting information decryption server 7 shown in FIG. 4.

In the control unit 12 of the wireless terminal 1A, the CPU 111 performs processing similar to Steps S21 to S24 in FIG. 2, which are described in the first embodiment, in Steps S41 to S44 in FIG. 5. Here, when setting information S can be read from the database 14 in Step S44 in FIG. 5, the setting information S can be transmitted to the access point 3. Thus, the CPU 111 advances the processing to Step S49.

The CPU 111 controls the setting information acquisition unit 13A to receive the encrypted setting information ES from the setting information distribution server 2A which corresponds to the access point 3 and is disposed (located in the vicinity thereof (Step S45 in FIG. 5).

The CPU 111 controls the communication unit 17 to transmit the encrypted setting information ES received in Step S45 and the wireless terminal ID of the wireless terminal, which is read from the database 14, to the setting information decryption server 7 through the network 16 (Step S46 in FIG. 5).

In response to receipt of the encrypted setting information ES and the wireless terminal ID from the wireless terminal 1A, the setting information decryption server 7 performs authentication of the wireless terminal 1A and decrypts the encrypted setting information ES by use of a secret key (Steps S61 and 562 in FIG. 6).

Next, the setting information decryption server 7 transmits the setting information S generated by the decryption processing in Step S62 to the wireless terminal 1A through the network 16 (Step S63 in FIG. 6 and Step S47 in FIG. 5).

In the control unit 12 of the wireless terminal 1A, the CPU 111 stores the setting information S received in Step S47 and the access point ID obtained in Step S42 so as to be associated with each other in the database 14 (Step S48 in FIG. 5).

Thereafter, in Steps S49 to S51 in FIG. 5, the CPU 111 performs processing similar to Steps S26 to S28 in FIG. 2 which are described in the first embodiment.

According to the second embodiment described above, as in the case of the first embodiment, the wireless terminal 1A can be easily and surely connected to the wireless LAN 4 via the access point 3. Furthermore, according to this embodiment, the setting information S is the encrypted setting information ES when the information is provided from the setting information distribution server 2A to the wireless terminal 1A. Moreover, the network 16 used for decryption is a communication line of which security is ensured. Thus, compared with the first embodiment, the setting information S can be distributed more safely.

Note that, the second embodiment described above has the system configuration in which decryption of the encrypted setting information ES is performed by the setting information decryption server 7. However, as long as security regarding a distribution method of a secret key, management after distribution and the like can be ensured, a system configuration in which the wireless terminal 1A performs decryption of the encrypted setting information ES may be adopted.

<Third Embodiment>

Next, description will be given of a third embodiment based on the wireless LAN connection system according to the first embodiment described above.

In the following description, characteristic portions of this embodiment will be mainly described. Moreover, constituent components similar to those of the first embodiment described above are denoted by the same reference numerals and repetitive description will be omitted.

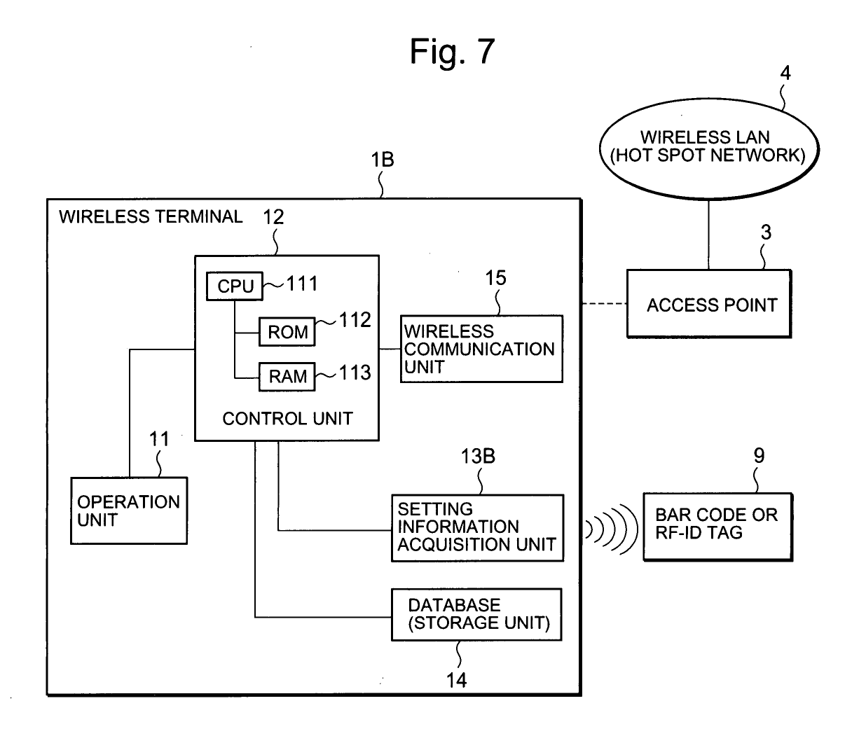

FIG. 7 is a block diagram showing a configuration of a wireless LAN connection system according to the third embodiment of the present invention.

The wireless LAN connection system shown in FIG. 7 includes, in a broad sense, a wireless terminal 1B, an access point 3, a wireless LAN 4 and a bar code (or a RF-ID tag) 9. Specifically, the wireless LAN connection system according to this embodiment includes the bar code (or the RF-ID tag) 9 instead of the setting information distribution server 2. Consequently, a configuration of a setting information acquisition unit 13B included in the wireless terminal 1B is also different from that of the setting information acquisition unit 13 included in the wireless terminal 1.

Specifically, in this embodiment, the setting information S is provided by the bar code or the RF-ID tag (a radio frequency ID tag) which is indicated by the block 9 in FIG. 7. The bar code or RF-ID tag 9 is disposed around the access point 0.3.

Meanwhile, in the wireless terminal 1B, the setting information acquisition unit 13B is a bar code reader (for example, a camera, a scanner and the like) when the block 9 is the bar code. Moreover, the setting information acquisition unit 13B is a RF-ID tag reader (for example, a radio reader) when the block 9 is the RF-ID tag. The setting information acquisition unit 13B reads the setting information S from the bar code (or the RF-ID tag) 9.

In the system configuration described above, the wireless terminal 1B acquires an access point ID from the access point 3 and reads the setting information S from the bar code (or the RF-ID tag) 9. Accordingly, when the wireless terminal 1B is authenticated in the access point 3 by transmitting the setting information S and the access point ID to the access point 3, the wireless terminal 1B receives a connection approval signal to the wireless LAN 4 from the access point 3.

Therefore, in the wireless LAN connection system according to this embodiment, the control processing executed by the access point 3 is similar to that described with reference to FIG. 3. Meanwhile, the setting information distribution server 2 does not exist in this embodiment.

Moreover, the connection processing executed by the CPU 111 in the control unit 12 of the wireless terminal 1B is approximately the same as the connection processing (FIG. 2) of the wireless terminal 1 described above. Here, the connection processing executed by the CPU 111 of the wireless terminal 1B is different from that shown in FIG. 2 in that the setting information S is read from the bar code (or the RF-ID tag) 9 by the setting information acquisition unit 13B instead of receiving the setting information S from the setting information distribution server 2 in Step S25 in FIG. 2. Since processing steps other than those described above are similar to those of the first embodiment, repetitive description will be omitted.

According to the third embodiment described above, as in the case of the first embodiment, the wireless terminal 1B can be easily and surely connected to the wireless LAN 4 via the access point 3.

<Fourth Embodiment>

Next, description will be given of a fourth embodiment based on the wireless LAN connection system according to the second embodiment described above.

In the following description, characteristic portions of this embodiment will be mainly described. Moreover, constituent components similar to those of the second embodiment described above are denoted by the same reference numerals and repetitive description will be omitted.

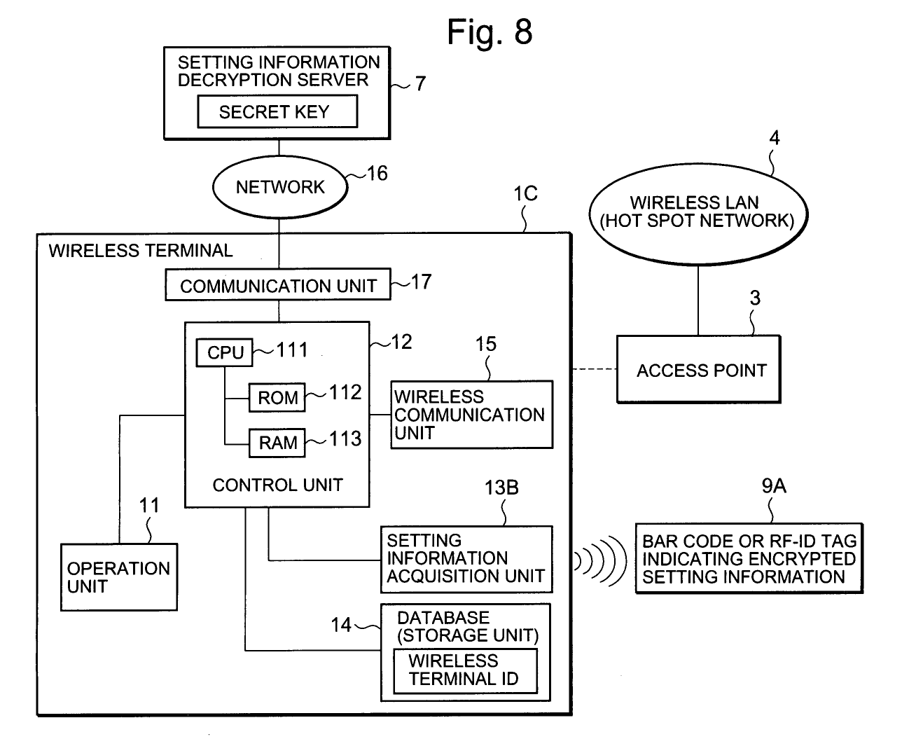

FIG. 8 is a block diagram showing a configuration of a wireless LAN connection system according to the fourth embodiment of the present invention.

The wireless LAN connection system shown in FIG. 8 includes, in a broad sense, a wireless terminal 1C, an access point 3, a wireless LAN 4, a setting information decryption server 7, a bar code (or a RF-ID tag) 9A and a network 16. Specifically, the wireless LAN connection system according to this embodiment includes the bar code (or the RF-ID tag) 9A instead of the setting information distribution server 2A. Consequently, a configuration of a setting information acquisition unit 13B included in the wireless terminal 1C is also different from that of the setting information acquisition unit 13A included in the wireless terminal 1A.

Specifically, in this embodiment, the setting information S means the encrypted setting information ES in the second embodiment and is provided by the bar code or the RF-ID tag (radio frequency ID tag) indicated by the block 9A in FIG. 8. The bar code or RF-ID tag 9A is disposed around the access point 3.

Meanwhile, in the wireless terminal 1C, the setting information acquisition unit 13B is a bar code reader (for example, a camera, a scanner and the like) when the block 9A is the bar code. Moreover, the setting information acquisition unit 13B is a RF-ID tag reader (for example, a radio reader) when the block 9A is the RF-ID tag. The setting information acquisition unit 13B reads the encrypted setting information ES from the bar code (or the RF-ID tag) 9A.

In this embodiment, when the wireless terminal 1C obtains the encrypted setting information ES from the bar code (or the RF-ID tag) 9A by use of the setting information acquisition unit 13B, the wireless terminal 1C transmits the encrypted setting information ES to the setting information decryption server 7 through the network 16 together with a wireless terminal ID of its own which is read from the database 14.

When the wireless terminal 1C can be authenticated by use of the received wireless terminal ID, the setting information decryption server 7 generates setting information S by decrypting the encrypted setting information ES by use of a secret key. Accordingly, the setting information decryption server 7 transmits the setting information S to the wireless terminal 1C through the network 16. The operation subsequently performed by the wireless terminal 1C, which has received the setting information S, between the wireless terminal 1C and the access point 3 is similar to that of the first embodiment.

Therefore, in the wireless LAN connection system according to this embodiment, the control processing executed by the access point 3 is similar to that described in the first embodiment with reference to FIG. 3. Moreover, the decryption processing executed by the setting information decryption server 7 is similar to that described in the first embodiment with reference to FIG. 6. Meanwhile, the setting information distribution server 2A does not exist in this embodiment.

Moreover, the connection processing executed by the CPU 111 in the control unit 12 of the wireless terminal 1C is approximately the same as the connection processing (FIG. 4) of the wireless terminal 1A described above. Here, the connection processing executed by the CPU 111 of the wireless terminal 1C is different from that shown in FIG. 4 in that the encrypted setting information ES is read from the bar code (or the RF-ID tag) 9A by the setting information acquisition unit 13B instead of receiving the setting information S from the setting information distribution server 2A in Step S45 in FIG. 4. Since processing steps other than those described above are similar to those of the second embodiment, repetitive description will be omitted.

According to the fourth embodiment described above, as in the case of the first embodiment, the wireless terminal 1C can be easily and surely connected to the wireless LAN 4 via the access point 3. Furthermore, according to this embodiment, the setting information S is the encrypted setting information ES when the information is read into the wireless terminal 1C. Moreover, the network 16 used for decryption is a communication line of which security is ensured. Thus, compared with the first and third embodiments, the setting information S can be distributed more safely.

Note that the present invention which has been described by taking the respective embodiments described above for example is achieved in the following manner. Specifically, after computer programs capable of realizing the functions in each of the flowcharts referred to in the description are supplied to each of the wireless terminals 1, 1A, 1B and 1C described above, the programs are read and executed by the CPU 111 of the wireless terminal.

According to the respective embodiments described above, the wireless terminals 1, 1A, 1B and 1C can be easily and surely connected to the wireless LAN 4 via the access point 3. Therefore, it is possible to relieve the user of troubles such as using a plurality of IC cards while appropriately switching the cards as in the case of the conventional wireless LAN connection.

Note that, in the respective embodiments described above, the description was made by taking the system configuration in which the setting information distribution server 2 (2A) is disposed (located) in the vicinity of the access point 3 (the wireless LAN 4) for example. However, the present invention is not limited to the system configuration described above. Accordingly, there is also assumed a system configuration in which the setting information distribution server 2 (2A) is disposed (located) in a position away from the access point 3 (that is, a place where the radio wave sent from the access point 3 cannot reach). For example, a system configuration as described below may be realized. Specifically, a previously specified route is taken so that the user carrying the wireless terminal 1 (1A and 1B) moves into an area within a communicatable range via the access point 3 after passing through an area within the short-range communication range by the setting information distribution server 2. To be more specific, the specified route of movement can be realized in such a manner that the setting information distribution server 2 is provided in an automatic ticket gate or in the vicinity thereof in a train station yard, for example, and a passage somewhat distant from the automatic ticket gate, a platform or the like becomes the communicatable range via the access point 3.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

1. A wireless LAN connection system including a wireless terminal and an access point connecting the wireless terminal to a wireless LAN, the system further comprising:
setting information provision means which provides setting information for connection to the wireless LAN,
wherein the wireless terminal includes:
a setting information acquisition unit which acquires the setting information from said setting information provision means; and
a connection request unit which receives, from the access point, identification information capable of specifying the access point, and transmits the identification information and the setting information to the access point in order to request connection to the wireless LAN through the access point, and
the access point connects the wireless terminal to the wireless LAN upon receipt of the setting information and the identification information from the wireless terminal.

2. The system according to claim 1, further comprising:
a setting information decoder for decoding the encrypted setting information,
wherein the setting information is previously encrypted setting information, and
in the wireless terminal, said connection request unit transfers the encrypted setting information to the setting information decoder and, upon receipt of decoded setting information from the setting information decoder, transmits the decoded setting information and the identification information to the access point.

3. The system according to claim 2, wherein a first network connecting the access point and the wireless terminal is different from a second network connecting said setting information decoder and the wireless terminal.

4. The system according to claim 3, wherein the second network is a network including a public wireless telephone line and the Internet.

5. The system according to claim 1, wherein
the setting information is previously encrypted setting information, and
in the wireless terminal,
said setting information acquisition unit includes decryption means which decrypts the encrypted setting information, and
said connection request unit transmits the identification information and the setting information decrypted by said decryption means to the access point.

6. The system according to claim 1, wherein
the access point transmits a predetermined radio signal in connecting the wireless terminal to the wireless LAN, and
in the wireless terminal, said connection request unit recognizes connection to the wireless LAN upon receipt of the predetermined radio signal from the access point.

7. The system according to claim 1, wherein the setting information includes at least information for authenticating the wireless terminal in the access point.

8. The system according to claim 1, wherein said setting information provision means is disposed in a service provision range by the access point.

9. The system according to claim 8, wherein, in the wireless terminal, said setting information acquisition unit acquires the setting information corresponding to the identification information from the access point when the setting information does not exist in the wireless terminal.

10. The system according to claim 1, wherein said setting information provision means is disposed any of in an automatic ticket gate around the access point and in the vicinity thereof.

11. The system according to claim 1, wherein said setting information provision means and said setting information acquisition unit are connected to each other through short-range communication based on prescribed standards.

12. The system according to claim 11, wherein the short-range communication is infrared communication.

13. The system according to claim 11, wherein the short-range communication is short-range wireless communication.

14. The system according to claim 1, wherein, in the wireless terminal, a bar code reader as said setting information acquisition unit acquires the setting information by reading a bar code as said setting information provision means.

15. The system according to claim 1, wherein, in the wireless terminal, a RFID tag reader as said setting information acquisition unit acquires the setting information by reading a RFID tag as said setting information provision means.

16. A wireless LAN connection method for connecting a wireless terminal to a wireless LAN via an access point, comprising:
providing the wireless terminal with setting information for connection to the wireless LAN from setting information provision means provided separately from the wireless terminal;
acquiring the setting information in the wireless terminal;
receiving, from the access point, identification information capable of specifying the access point in the wireless terminal and transmitting the identification information and the setting information to the access point in order to request connection to the wireless LAN through the access point; and
connecting the wireless terminal to the wireless LAN through the access point upon receipt of the setting information and the identification information from the wireless terminal.

17. The method according to claim 16, wherein
the setting information is previously encrypted setting information, and
said connecting includes:
decoding the encrypted setting information in a setting information decoder provided separately from the wireless terminal; and
transmitting decoded setting information and the identification information to the access point upon receipt of the decoded setting information from the setting information decoder.

18. The method according to claim 17, wherein a first network connecting the access point and the wireless terminal is different from a second network connecting the setting information decoder and the wireless terminal.

19. The method according to claim 16, wherein
the setting information is previously encrypted setting information, and
said requesting includes:
decrypting the encrypted setting information in the wireless terminal; and
transmitting decrypted setting information and the identification information to the access point.

20. The method according to claim 16, wherein the setting information includes at least information for authenticating the wireless terminal in the access point.

21. The method according to claim 16, wherein the setting information provision means is disposed in a service provision range by the access point.

22. The method according to claim 21, wherein, in said acquiring, the setting information corresponding to the identification information is acquired from the access point when the setting information does not exist in the wireless terminal.

23. The method according to claim 16, wherein the setting information provision means is disposed any of in an automatic ticket gate around the access point and in the vicinity thereof.

24. A wireless terminal connected to a wireless LAN via an access point, comprising:
a setting information acquisition unit which acquires setting information for connection to the wireless LAN from setting information provision means provided separately from the wireless terminal; and
a connection request unit receives, from the access point, identification information capable of specifying the access point, and transmits the identification information and the setting information to the access point in order to request connection to the wireless LAN through the access point.

25. The wireless terminal according to claim 24, wherein
the setting information is previously encrypted setting information, and
said connection request unit includes:
a transfer unit which transfers the encrypted setting information to a setting information decoder provided separately from the wireless terminal; and
a transmission unit which transmits decoded setting information and the identification information to the access point upon receipt of the decoded setting information from the setting information decoder.

26. The wireless terminal according to claim 24, wherein
the setting information is previously encrypted setting information,
said setting information acquisition unit includes decryption means for decrypting the encrypted setting information, and
said connection request unit transmits the identification information and setting information decrypted by said decryption means to the access point.

27. The wireless terminal according to claim 24, wherein said connection request unit recognizes connection to the wireless LAN upon receipt of a predetermined radio signal from the access point.

28. The wireless terminal according to claim 24, wherein said setting information acquisition unit is a communication device which performs short-range communication based on said setting information provision means and prescribed standards.

29. The wireless terminal according to claim 24, wherein said setting information acquisition unit is a bar code reader which reads a bar code as said setting information provision means.

30. The wireless terminal according to claim 24, wherein said setting information acquisition unit is a RFID tag reader which reads a RFID tag as said setting information provision means.

31. A wireless LAN connection system including a wireless terminal and an access point connecting the wireless terminal to a wireless LAN, the system further comprising:
setting information provision means for providing setting information for connection to the wireless LAN,
wherein the wireless terminal includes:
setting information acquisition means for acquiring the setting information from said setting information provision means; and
connection request means for receiving, from the access point, identification information capable of specifying the access point and transmitting the identification information and the setting information to the access point in order to request connection to the wireless LAN through the access point, and
the access point includes:
connection means for connecting the wireless terminal to the wireless LAN upon receipt of the setting information and the identification information from the wireless terminal.

32. A wireless terminal connected to a wireless LAN via an access point, comprising:
setting information acquisition means for acquiring setting information for connection to the wireless LAN from setting information provision means provided separately from the wireless terminal; and
connection request means for receiving, from the access point, identification information capable of specifying the access point and transmitting the identification information and the setting information to the access point in order to request connection to the wireless LAN through the access point.

33. A computer program for controlling operations of a wireless terminal connected to a wireless LAN via an access point, the computer program implements a computer to realize:
a setting information acquisition function of acquiring setting information for connection to the wireless LAN from setting information provision means provided separately from the wireless terminal; and
a connection request function of receiving, from the access point, identification information capable of specifying the access point and transmitting the identification information and the setting information to the access point in order to request connection to the wireless LAN through the access point.
